(19) United States
(12) Patent Application Publication
(10) Pub. No.: US 2014/0147821 A1
(43) Pub. Date: May 29, 2014

(54) EXERCISE MANAGEMENT SYSTEM

(71) Applicant: Corinne BERNARD-PAROLY, Harrison, NY (US)

(72) Inventor: Corinne BERNARD-PAROLY, Harrison, NY (US)

(21) Appl. No.: 14/091,571

(22) Filed: Nov. 27, 2013

Related U.S. Application Data
(60) Provisional application No. 61/731,022, filed on Nov. 29, 2012.

(51) Int. Cl. G09B 5/02; G09B 5/06

(52) U.S. Cl. CPC G09B 5/02; G09B 5/06
USPC 434/247

(57) ABSTRACT

This invention pertains to a system for providing exercise programs to users based on regimes prepared by health care practitioners. Each regime is automatically converted into a set of exercise sessions, each session consisting of one or more exercises. The exercise sessions are provided to users as audio/video programs. Preferably, an avatar in the video portion of each program performs the respective exercises and together with the audio portion provides prompts, encourages and instructs the user in following and performing the exercises.

### RELATED APPLICATIONS

This application claims priority to application Ser. No. 61/731,022 filed Nov. 29, 2012 and incorporated herein by reference in its entirety.

### BACKGROUND OF THE INVENTION

A. Field of Invention

This application pertains to a system and method of generating and presenting an exercise regimen to a person that may be based on a prescription by a health professional. The regimen is presented to the person on a display, preferably by an avatar animated using a game engine.

B. Description of the Prior Art

Exercising regimens are provided for many people for many reasons, such as a means for promoting recovery after some illness, losing weight, maintaining the person's physical shape, training for an athletic event, and so on. Regimens are typically prescribed by doctors or other health-related professionals, such as physical or occupational therapists, or they can be self-imposed. There are also various audio/visual materials available for demonstrating how to perform exercises. However these materials are generally generic and cannot be customized to the needs of a particular person.

It is well known that people find in it much more easier to perform exercises, especially consisting of long, tedious regimens, if they could share the activity or do the same activity with another person. That is one of the reasons why gyms and other venues were several people can exercise together have become so popular. However, because each person, especially a person recovering from an illness, has his or her personal needs and requirements, existing exercising sessions at a gym

### SUMMARY OF THE INVENTION

Briefly, this application pertains to a system for providing exercise programs to users based on regimes prepared by health care practitioners. Each regime is automatically converted into a set of exercise sessions, each session consisting of one or more exercises. The exercise sessions are provided to users as audio/video programs. Preferably, an avatar in the video portion of each programs performs the respective exercises and together with the audio portion provides prompts, encourages and instructs the user in following and performing the exercises.

In order to make the system user friendly, each avatar is custom designed for the users. In addition, elements in each program, including background images, background music, the appearance of avatars, and so on, can be changed from session to session.

In one embodiment, the movements of the avatars are generated using a game engine. In other words, each exercise for a given exercise session consists of a series of movements for various body parts. These series of movements are provided to the game engine which then generates a video of the respective avatar performing the required movements.

In one embodiment, a server is provided that receives the regimes and uses libraries to generate avatars and the other elements required for each exercise session. During each session, the user is shown not only the avatar but also various information including historic data related to his performance of the exercise sessions.

### DESCRIPTION OF THE DRAWINGS

FIG. 1 shows a general block diagram of a system for providing exercise programs for a user in accordance with this invention;

FIG. 2 shows a block diagram for the server of FIG. 1;

FIGS. 3A shows a general flow chart illustrating the process used by the server for generating the exercise program;

FIG. 3B shows a flow chart for generating the sequence of exercises within an exercise session within the program;

FIG. 3C shows a general flow chart of how the server delivers an exercise session on demand from a user;

FIG. 3D shows a flow chart of how the server updates its information at the end of an exercise session;

FIG. 4 shows a sequence of aural and visual segments that make of a typical exercise session;

FIG. 5 shows a somewhat diagrammatic representation of how the respective avatar and related information is shown to a user during an exercise session;

FIG. 6 shows a block diagram of a user device used to obtain an exercise program from the server; and

FIG. 7 shows a flow chart of the operation of the device of FIG. 6.

### DETAILED DESCRIPTION OF THE INVENTION

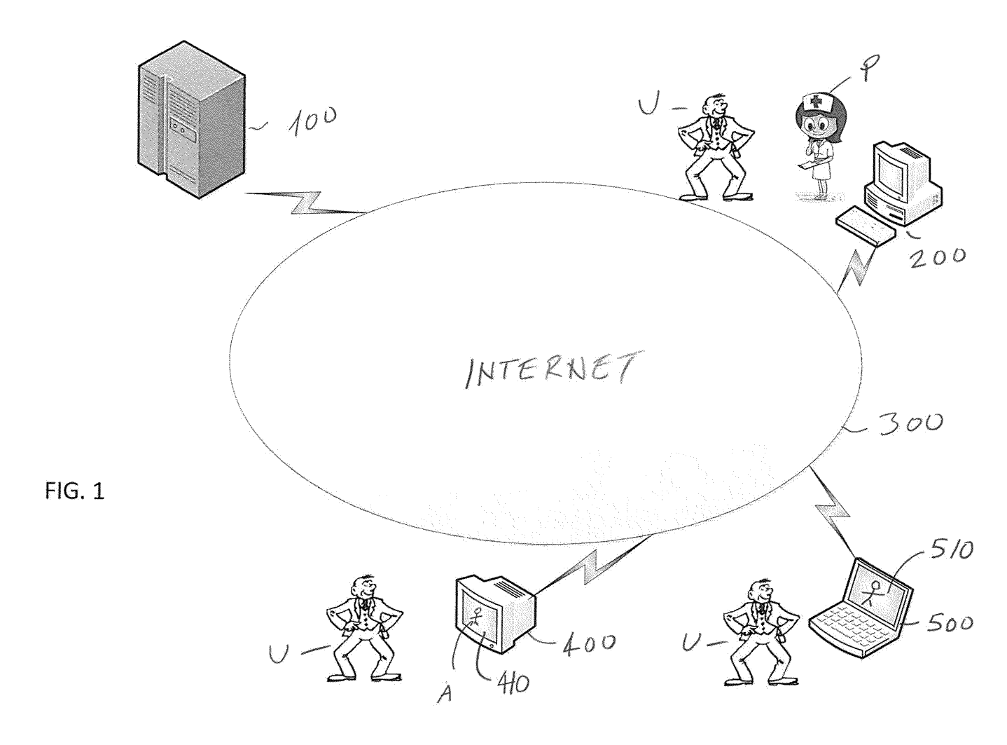

In a typical scenario, as shown in FIG. 1, a user U visits a health care practitioner P who examiners the user and his medical records and based on various factors, describes a regimen R of exercises. This regimen normally consists of several exercises E1 . . . En. Practitioner P may be a doctor, a physical or occupational therapist, a trainer, etc.

The practitioner P then, using her PC 200 interacts with an exercise program server 100 through the Internet 300 to generate an exercise program EP based on the prescribed regimen R. The regimen may be generated by the practitioner P electronically on her device 200. In one embodiment, the practitioner P generates the regime R by first accessing a website associated with server 100 and then filling out the information defining the prescribed regimen. If the user U is an old patient, the practitioner P also associates the exercise program EP with the profile of the user U. If user U is a new patient, the practitioner generates a profile for the user, U and provides other information including avatar information needed to generate a personalized avatar for the user as well as the exercise program ER This information is then used by the server 100 to generate the appropriate exercise program ER As discussed above, the regimen could also be created by a health and exercise trainer working with user U or even by the user U himself.

Alternatively, the practitioner P generates the regimen R manually (In this latter case, the regimen is transferred to the server in an electronic version at a later time).

The exercise program EP includes several exercise sessions ES typically to be performed over a period of time, e.g., several months, to be performed one or more times of week.

After the user visited the practitioner P, he can access the specific exercise program EP tailored for him, through the internet 300 and a permanent user device 400. Device 400 may be located for example, in the user's home. The device 400 may be associated with a data storage 410. In one embodiment, the server 100 transmits the whole exercise program to the user device 400 which is then stored in the data storage 410 and the user is then free to interface with the exercise program EP at will, without any further information required from the server 100. In an alternate embodiment, the individual exercise sessions ES are provided one at a time on demand and are customized as necessary. As will be described in more detail below, each of the sessions ES are stored in the data storage 410 and the user then can access either the latest ES or any of previously received sessions. Alternatively, for example, if he is travelling and is using a temporary access device 500 , instead of providing the whole program EP, the server 100 provides only one of the sessions ES to the user. For example, the user U may be using a laptop as the temporary access device 500 in a hotel room.

The permanent device 400 is preferably a desktop or laptop based device, although it could also be incorporated into or implemented on a tablet, or even a hand held device. In any event, the user can initiate an exercising session at anytime or place where and when he is ready for it. Thus the device 400 can be used in an office, at home, on the road in a hotel room, a health spa, etc.

As mentioned above, the device 400 can receive the whole program EP at once, but preferably receives each session separately. More specifically, when the user U is ready for a session, he signs in on server 100 from his device 400 (or 500) (preferably through the internet 300) that he is ready for a session.

Preferably, data D is generated by device 400 each time user U is viewing (and presumably performing) an exercise session ES. This data D, includes the time and date the viewing has occurred. This data D is sent back for tracking user U to the practitioner and the server 100.

One important feature of the invention is that during each exercising session, the user U is prompted to do each of the particular exercises designated by the respective session. The device 410 includes a display 414 and one or more speakers 416. Preferably, the prompting is done audio visually by presenting on display 414 an avatar A and playing sounds through one or more speakers 416. (Temporary device 500 has similar displays and speakers, not shown).

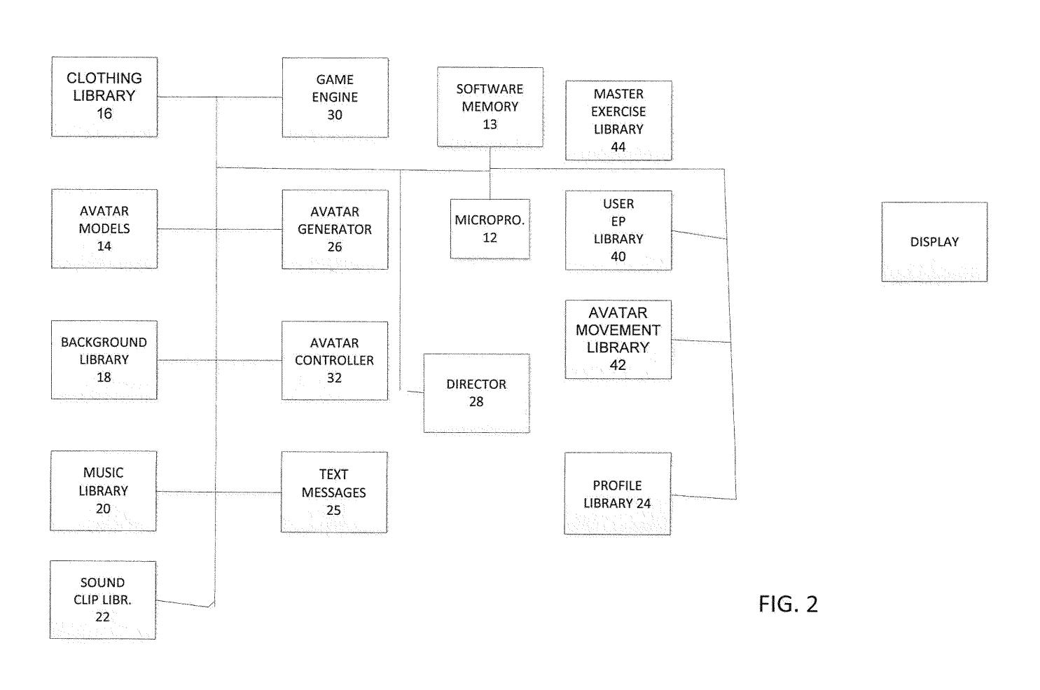

The process for generating the exercise program EP and its components, the exercise sessions ES is now described. As shown in FIG. 2, the server 100 includes a microprocessor 12 and several modules that may be implemented by software running on the microprocessor 12 (and stored in a memory 13) however individual modules are illustrated herein for the sake of clarity.

The avatar A is an anatomically correct (preferably human) figure with a head, a body and arms and legs that move to simulate each particular exercise. The avatar could be a generic figure, however, preferably the image of the avatar is customized in order to provide more realism, enhance the quality of the experience, and recreate an environment and experience for the user U (or more than one users) that simulates a sharing between several people or the experience of exercising under the direction of a trainer. For this purpose, a plurality of models for avatars are provided in a model library 14. The images may include models having different characteristics such, height, weight, skin color, hair color, hair cut, etc. In one embodiment, images may be of well known real or imaginary persons. A clothing library 16 holds images of various articles of clothing to be worn by the avatar. Various colors for the articles of clothing, including well known insignia or brand names may also be included in the clothing library. A background library 18 provides various backgrounds against which the image of the avatar A is presented.

A music library 20 holds various songs and a sound clip library 22 holds sound clips of instructions and other sounds.

A text message library 25 holds text messages.

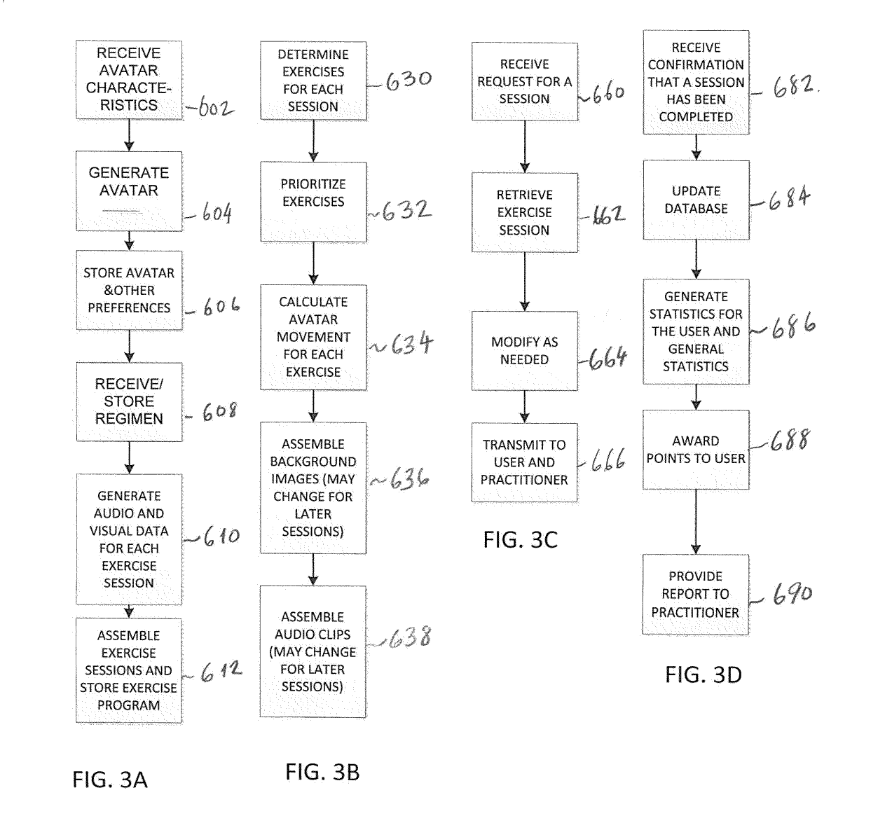

When the user U is signed up to the system, a preconstructed avatar is either assigned to him or a new avatar is created for him either by practitioner P or some other personnel. For example, as shown in the flow chart of FIG. 3A, in step 600, the desired avatar characteristics are provided to avatar generator 26 and based on these characteristics a suitable avatar image is selected from the avatar models 14. For example, if the user U is a female, she may prefer to view an avatar that is also female. In addition, clothing articles and colors are also chosen for the avatar from clothing library 16. All these characteristics may be constant for all the exercise sessions, or they may change from session to session (or at will) to add to the realistic effects. For example, at the beginning of an exercise session the user may send a message to the server that she wants to change the cloths on the avatar assigned to her. The avatar generator 26 performs the necessary changes and generates a new avatar for the user to be used for that exercise session or a future session (step 604). Once the avatar for the user is constructed by generator 26, in step 602, the avatar and other parameters and information associated with a specific user U (including his musical preferences, background preferences, etc.) are stored in the profile library 24 (step 606). If the user has a profile already, it is retrieved from the profile library 24 as needed.

A master exercise library 44 is used to store all the exercises that the server 100 can incorporate into an exercise program EP.

A regimen prescribed by the practitioner P is received by the server 100 and stored in the profile library for each user U (step 608). Next, in step 610, the regimen for user U is used to generate the corresponding exercise program EP with its component exercise sessions ES is generated and stored in EP library 26. Each exercise called for by regimen R is retreated from the library 44.

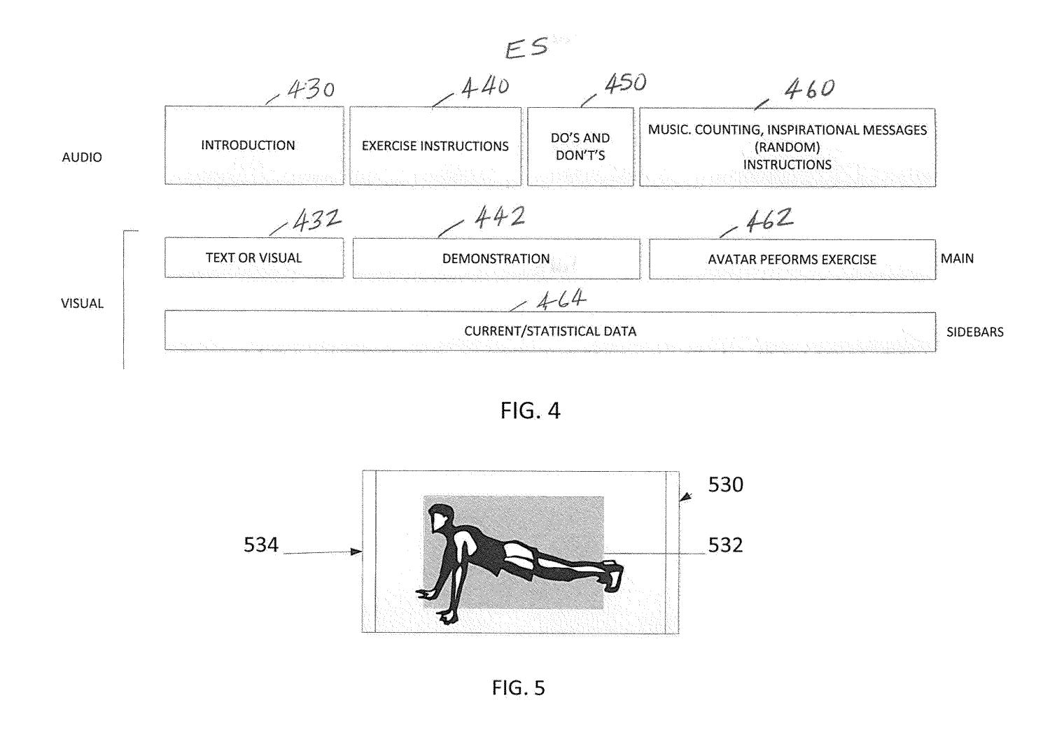

A typical exercise session, as shown in FIG. 4 includes an audio and a visual component, each component consisting of respective segments. Preferably, the visual component includes a main section which is generally shown at the center of the displays 410, 510 and one or more sidebars that are arranged around the perimeter of the displays. More specifically, as shown in FIG. 5, a composite image 530 shown during an exercise session ES may include a main section 532 showing avatar A (with some optional background images that have been omitted for the sake of clarity) and one or two side bars 534.

Referring back to FIG. 4, each session ES starts off with an introduction segment 430, in which the user U is provided with general information about the session. During this time, text or other visual images are shown in main section 552 (segment 432). Next, exercise instructions 440 are provided, preferably accompanied by a visual demonstration segment 442 in which the avatar demonstrates the exercises. Nextm additional pointers such as Do's and Don'ts are provided both audially and visually (segments 450, 442). Finally, the actual exercise segments 460, 462 are played. During these segments, the avatar is shown performing the respective exercises, while the audio track plays a real time count synchronized with the movement of the avatar. So, for example, if an exercise session includes ten pushups, the avatar performs pushups and each pushup is counted out loud in the sound track. Additional sound clips are also played either in the background (e.g., music) or other messages are played between the counts, including inspirational messages (that may be played at random), additional instructions, and so forth.

The session ES can be interrupted and resumed at any time.

Moreover, some of the instructions and messages can be shortened, or eliminated after they have been played several times. For example, if the same sessions ES is being played for the fifth time, the introduction can be eliminated, together with all or some of the exercise instructions or do's and don'ts. The speed at which the exercise is performed can also be changed automatically. For example, initial, the avatar can be performing pushups at a low rate, e.g., 1 per second. if the user is playing the same session ES the fourth time in a week, the rate may be increased to four pushups in three seconds. After 10 sessions, the rate may be increased to 2 pushups per second. The user can optionally change this rate manually. As discussed above, long and short term changes may be made as well. For example, the background images can be changed with each season, the colors of the clothing form the avatar may be changed, the music played may be changed, the music may be changed every time the session is played, etc. In this manner, the user can view (and hopefully participate with) the same exercise session several times and each time the experience will be slightly different to make it a more entertaining and exciting experience for the user. Preferably, these changes are made by the server before the respective session ES is downloaded.

The sidebar 534 is used to provide additional information during each session, such as the time when the session was started, how long is the session, how much time has elapsed since the session has started, how much is left in the session, how many times an exercise has been repeated, what is the next exercise within the session, what exercises are included in the next session, how many times the user has watched this current session, etc.

Returning to FIGS. 2 and 3A, after a regimen is stored in step 608, a director 28 analyzes the regimen, collects the required background images, sound clips, text messages, and puts together the audio and visual tracks for each of the exercise session (illustrated in FIGS. 4 and 5, step 610 in FIG. 3A) of the program, and stores them in the user EP library 40 (step 612).

Importantly an avatar movement library 42 is provided which defines a series of movements required to be performed by the avatar A for each exercise. For example, for each pushups, the arms, legs, torso, head and neck of the avatar have to perform certain precise movements. A game engine 30 and an avatar controller use the information from the library 42 to generate video images of the respective avatar performing the respective exercise in real time. This information becomes part of the respective ES and is stored with all the other information into user EP library 40. Moreover, even for the same ES, some details of the exercise, e.g., the rate at which an exercise is performed by the avatar is changed either automatically or in response to a request/command from user U.

In one embodiment, the game engine 30 and the director 28 are placed in the user device 400, 500 and the renderings for avatar's motions are generated there rather than in the server.

FIG. 3B shows more details for step 612. More specifically, many exercise sessions consist of a plurality of exercises with the user taking several positions for each exercise and which different exercising addressing different muscles, tissues, joints, etc. For example, one exercise session could include a first set of exercises with the user standing, a second set of exercises with the user lying on his left side and a third set of exercises while the user is lying on his right side. Another exercising session includes a first set of exercises requiring a set of exercising involving a first equioment (e.g., a chin bar), a second set of exercises involving a second equipment (e.g. weight lifting) and so on. The director 28 reviews and categorizes the exercises within each exercise session based on a predetermined criteria, e.g., user position, equipment used, etc. (Step 630). Next, the director 28 prioritizes and orders the exercises in a sequence using predetermined rules. For example, the director may order the exercises so that all the exercises on the left side are done, followed by all the exercises on the right side, all the exercises, requiring standing, etc. Alternatively, the director 28 may put all the exercising requiring a chin bar followed by exercising requiring weights, etc. In another alternative embodiment the director 28 may group all the exercises together that are directed at strengthening the arms, followed by exercises for the leg, etc. In yet another embodiment, the director 28 may order the exercises in a manner that does not tire out certain members. So for example, exercises for the arm may be interleaved with exercises for the leg.

Once the sequence of exercises is set by director 28, in step 634 the proper avatar movements are calculated for the sequence defined in step 632. Next, one or more background pictures are obtained (step 636), the appropriate songs and sound clips are added (step 638) and the resulting exercise session is stored in library 40. Again, some of the determinations in steps shown in FIG. 3B can be permed by the user devices 400, 500. This later configuration is especially desirable if the user desires to change some of the exercise session parameters.

As shown in FIG. 3C, the exercise program for a user has been determined, the server 100 is ready for operation. Typically, in step 660 the server 100 receives a request for an exercise session ES within exercise program ER The server 100 checks the progress of the user and retrieves the appropriate exercise session (step 662). In step 664 the exercise session ES modified, if needed. For example, the exercise program EP may have been initially set up in the summer but the request for the altest ES occurs in the winter. The clothing for the avatar and the background images are changed to reflect that it is winter and not summer.

Finally in step 666 the requested exercise session is sent to the user U and the practitioner may receive a notification of this matter as well.

As shown in FIG. 3D, once a user finishes watching any exercise session, the server 100 is notified by device 400, 500. The notification may include additional information, such as where was the session viewed, how much of the session was viewed by the user, etc. (step 682) In step 684 statistics are generated regarding user U and any other user managed by the server 100 and this information is entered into the profile liberty 24 as well as other databases interested in such statistics.

Certain milestones can be set within the server and when a user reaches certain milestones, rewards may be awarded to the user (step 688). For example, the user may be rewarded with points if he completes the first N sessions in a predetermined time. Information is also sent to the practitioner P so that she can see what is going in with user U. For example, the practitioner may want to know if the user U has not finished some exercise sessions within a predetermined period of time, e.g. 3 weeks.

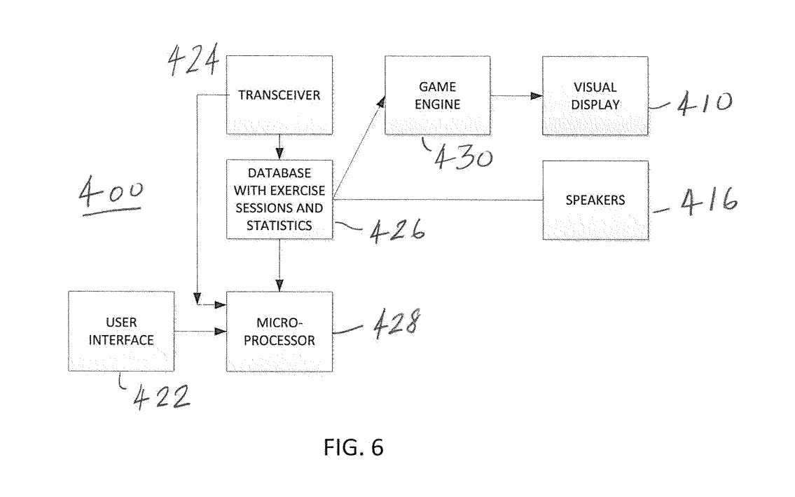

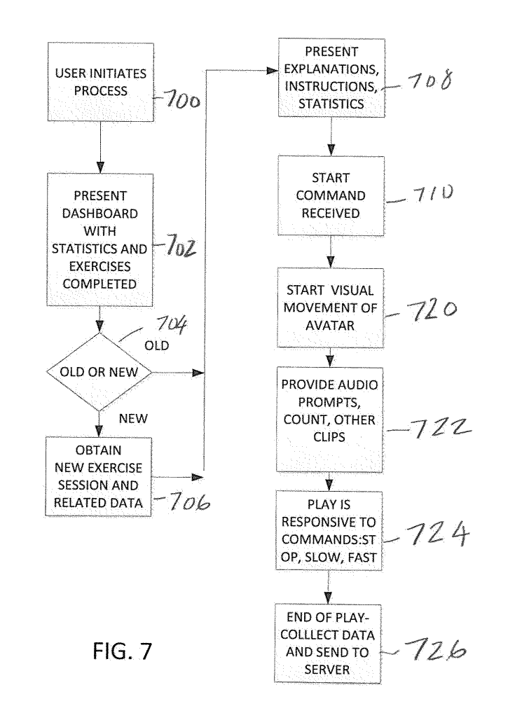

FIGS. 6 and 7 provide further detail of the operation of device 400. In addition to screen 410 and speakers 416, device 400 further includes a user interface 422 (such as a mouse, a keyboard, etc.), a transceiver 424 exchanging signals, normally with server 100, a database of downloaded exercise sessions and statistics associated with user U and his performance, and optionally, a game engine 430 as discussed above. When the user U is ready to exercise he initiates the process in step 700 (for example by activating an application on device 400. In step 702 a dashboard (not shown) is presented to the user U indicating various information and statistics, such as when was the last time he exercised, what was the latest ES he has viewed, etc. The dashboard also includes icons for exercise sessions that have been previously downloaded into database 426 as well as the next ES that is due to be downloaded. In step 704 the user can select either one of the previously loaded ES or chose a new ES. If that is the user's choice, the latest ES is downloaded.

In step 708 the user is presented with the introduction, explanation, instructions, statistics relevant to the user S. This step includes presenting to the user sections 430, 440, 450. In step 710 the user U initiates a start command indicating that he is ready to go on. In steps 720 and 722 the avatar A starts exercising with accompanying sound clips, prompts, count, etc. During play, the user U can issue commands requesting that the exercise session be terminated, stopped temporarily, slowed down, speeded up, cancelled, etc. (step 724). When the session is finished an appropriate command is sent to the server 10 and optionally to practitioner P to indicate the progress of user U, and other information, as discussed, by various conventional means, such as an email.

In one embodiment, the master exercise library contains a complete contains files of different exercises, each file being generated by recording a person performing the respective exercise using anywhere from one up to 34 or more cameras, digitizing the movements of the person(for example, by recording the movement of the person's limbs, joints, etc.) and recording the movement. The game engine is then used to generate a video of an avatar performing the same movement for the same exercise. Once this library is available, one or more practitioner's P can chose a regime of exercises for one or more users, and the regime for each user can be customized for his or her needs, by choosing the exercises for each regime, the number of times it can be repeated, variations in the repetition rate (e.g., a person can start with 5 sits ups and gradually go 15 sits up in 3 months). Moreover, the practitioner can also modify some of the exercises. So, for example, for a leg lift, the practitioner can chose a “hold period” of 0-10 seconds during which the position of the leg is maintained still up in the air.

Other parameters may be changed as well. For example, in one embodiment, the practitioner can prescribe whether during an exercise the avatar will hold an arm, a leg, etc, at a predetermined angle of let's say 30-75 degrees. Other parameters associated with specific exercises can be made variable as well. When the practitioner accesses a website associated with server 100, he can be presented with menus indicating the various exercises available, and for exercises with variable parameters, the practitioner can pick and choose the parameters (optionally with some suggested or recommended values for these parameters).

One important feature of the invention is that an exercise program may include a calendar option that tracks the days on which the user is expected to exercise, the exercise to be performed during each day (if any), etc. Each time the user U watches a respective exercise session, the system assumes that the user has performed the recommended exercises and the calendar is advanced accordingly (e.g., performing situps 10 times the first week, 12 times the second week, etc.). The practitioner can receive real time feedback and can send a modification to the regime, if the practitioner P feels it is necessary.

One advantage of the invention is that during the generation of the data for each exercise, each movement can be performed by the live actor, but advantageously, duplicate movements may be eliminated. So, if for an exercise, an actor lifts his right leg and is recorded and then the movement for the left leg is required, the movement for the left leg need not be recorded but can be extrapolated for the avatar from the recording of the right leg. In other words, an exercise regime may require the lifting of the right leg 5 times followed by the lifting of the left leg. The director is configured to automatically obtain the data for the right leg once, extrapolate the movement for the left leg and the loop the data for the right leg first five times, followed by the extrapolated movement of the left leg repeated five times.

Moreover as part of the sorting process described above, for one session the right leg may be shown as moving first for the first week, and then the left leg is shown as moving first for the second week, and so on. In addition, in order to relieve the monotony, assuming for example, that a user must perform exercises five times a week, during sorting and arranging of the exercises, the avatar can be shown from different angles. So on Monday, in the first scene the avatar may be shown from the left side, on Tuesday from the left side, on Wednesday from the front, etc. For each subsequent scene on each day, the avatar could be shown from different angles as well. The angles are selected originally by the director to illustrate how an exercise is to be performed but can be changed dynamically from day to day, week to week, etc.

One feature of the invention is that each repetition for each exercise is counted out loud on the audio track to encourage the user and so that the user does not have to do it himself. So, for example, if 15 pushups are required, the avatar takes the initial position for pushups, a “one” is heard on the audio track and the avatar performs the first pushup, then a “two” is heard on the audio track while the avatar is performing a second pushup and so on. Thus each repetition is tagged with a number and the number is announced concurrently with the execution of the exercise by the avatar (and hopefully the user). In this manner, each repetition is tagged with a number and the number is then announced as a count. Of course, the counting is properly synchronized with the speed at which the avatar is performing the exercise. If the avatar is performing pushups fast, the counting is kept up so that it is announced at the same rate.

Numerous modifications maybe made to this invention without departing from its scope as defined in the appended claims.

What is claimed is:

1. A system for generating an exercise program comprising:
a server receiving a regime defining a plurality of exercises over a period of time to be performed by a user, said server including a movement library defining each exercise of said regime as a plurality of movements of body parts, and a game engine connected to said library and adapted to generate a video program showing an avatar with avatar body parts moving together to simulate each of said exercises; and
a user device receiving said video program and selectively presenting said video program to the user.

2. The system of claim 1 wherein said server further includes an audio library of audio clips, said server being configured to add audio clips to said video program.

3. The system of claim 1 further comprising an avatar generating module configured to select said avatar from an avatar library.

4. The system of claim 1 wherein said avatar generating module is associated with a clothing library with information related to clothing, said avatar generating said avatar with clothing articles from said clothing articles on demand.

5. The system of claim I wherein the movement of the avatar in said video program is changed by said server in response to commands.

6. A method of generating an audio/video program for a user to prompt the user to perform an exercise session, said audio/program including a video component, said method comprising the steps of:
Receiving a regimen of exercises for the user;
Retrieving from an avatar library a plurality of body part movements corresponding to said exercises;
Using a game engine, generating said video program by creating images of an avatar performing said exercises based on information from said avatar library; and
Presenting said video program to the user.
